(19) United States
(12) Patent Application Publication
(10) Pub. No.: US 2010/0133221 A1
(43) Pub. Date: Jun. 3, 2010

(54) Modified disposable container

(76) Inventor: Tonya Ann Levis, Salem, VA (US)

Correspondence Address: Tonya A. Levis, 1500 Young St, Salem, VA, 24153, US

(21) Appl. No.: 12/581,015

(22) Filed: Oct. 16, 2009

Related U.S. Application Data
(63) Continuation-in-part of application No. 11/387,627, filed on Mar. 23, 2006, now abandoned.

(51) Int. Cl. A61J 11/04; B65D 1/02

(52) U.S. Cl. 215/11.1; 215/40

(57) ABSTRACT

The present invention provides modifications to conventional disposable bottles such as disposable, water-filled bottles. One such modification includes a wider opening in the neck of the disposable bottle. Another modification comprises enlarging the size of the threads on the outside of the necks to allow the cover of the bottles to be replaced with other attachments.

### CROSS-REFERENCE TO RELATED APPLICATIONS

This application is a continuation-in-part of U. S. patent application Ser. No. 11/387,627, entitled “Modified liquid/substance container” filed on Mar. 23, 2006, the entire content of which is expressly incorporated herein by reference in their entireties.

### TECHNICAL FIELD

The present invention relates generally to the field of disposable, plastic substance containers such as plastic beverage bottles and, more particularly, to modifications to such containers.

### BACKGROUND OF THE INVENTION

Bottled water has long been used for preparing drinks in feeding bottles, such as formula for infants. The feeding bottles generally comprise a nipple removably fixed to the bottle with a wide neck by means of a nipple attachment having an internally-threaded ring adapted to be screwed onto the neck The bottles, nipple attachments and nipple are typically washed and sterilized before the bottles are filled.

There are many problems that arise when trying to mix powders such as powdered baby formula or other drink mixes with water in conventional plastic water bottles. At the present time, conventional plastic water bottles have narrow, externally-threaded necks, typically having diameters of about 26-28 mm. The narrow openings in the necks of such conventional plastic water bottles make it difficult to add the powdered formula or drink mix, usually resulting in spilling the powder which is a waste. The small size also means that conventional nipple attachments, which are typically larger in size than the necks of the bottles, cannot be directly attached to the bottles. Moreover, the threads on the necks of such disposable bottles are small and only accept the cover used to keep them closed.

The difficulties in adding powder mixes, especially powdered baby formula, into the water in conventional disposable water bottles means that the water must be poured out of the disposable bottle and into another container, such as a regular feeding bottle in the case of powdered baby formula, followed by the powdered mix. Oftentimes, people encounter difficulties in pouring the bottled water into a second container such as spillage of the water or pouring in the wrong amount of water. When traveling this results in double the number of containers or bottles to contend with (the empty disposable and the second container or baby bottle). When home, this results in a sink full of cups or baby bottles that must be washed and sterilized, thereby resulting in an undue waste of water and detergent used in cleaning. It also results in a waste of time because the readily-available disposable water bottles are already sterile and filled with water.

### SUMMARY OF THE INVENTION

It is an object of the present invention to provide a disposable bottle having a modified neck. In one embodiment, the modification includes making the necks of conventional disposable bottles wider such that they are the same size as the threaded ring of the nipple attachment. This would allow for ease and less spillage of the powder when pouring powdered formula or other powdered mix into the disposable bottle. It would also allow for conventional nipple attachments to be directly attached to disposable water bottles.

In another embodiment, the external threads of the disposable bottles are made larger such that they can directly accept the internally-threaded nipple attachments.

In yet another embodiment, the necks of the disposable bottles may be elongated slightly. Making the neck a little longer adds extra space in the disposable bottle not occupied by water or other liquid. The extra space makes it easier to add a powdered substance to the bottle because it eliminates overflow of the liquid from the bottle and, thereby, waste of the liquid and/or powdered substance.

Each of these modifications will also eliminate much waste that now exists by reducing the amount of water and detergents needed in cleaning. In addition, already-existing feeding bottles are not easily recycled. Disposable water bottles are easier to recycle, thereby easing the strain on the environment.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is an exploded side view of a conventional disposable bottle;

FIG. 2 is an exploded side view of a traditional baby feeding bottle;

FIG. 3 is a perspective view of one embodiment of the present invention; and

FIG. 4 is a perspective view of a second embodiment of the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references.

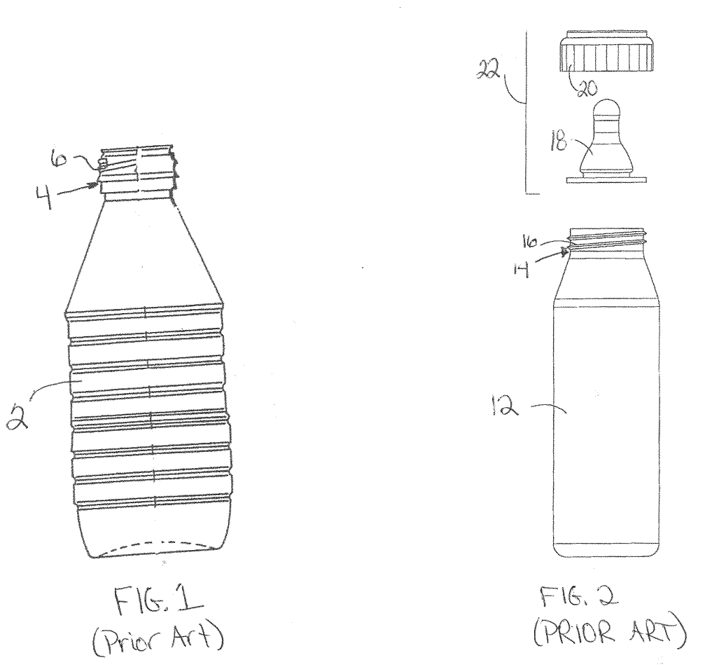

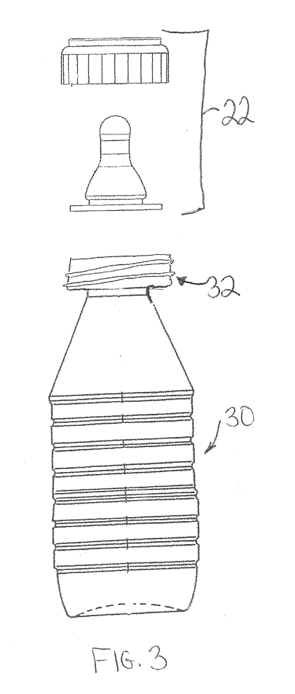

Referring first to FIGS. 1 and 2, there are shown therein, respectively, a conventional disposable bottle and a conventional baby feeding bottle. The bottles are depicted and described herein to better explain the present invention.

A conventional disposable, pre-filled bottle 2, such as a water bottle, is shown in detail in FIG. 1. The conventional bottle has a relatively narrow, externally-threaded neck 4 that includes threads 6. For bottles of this type, neck 4 has a diameter of about 26-28 mm. A conventional cover (not shown) is threadable onto the narrow neck of the conventional bottle.

Similarly, a traditional feeding bottle 12, such as a baby bottle, is shown in detail in FIG. 2. The traditional feeding bottle has an externally-threaded neck 14 that includes threads 16. A traditional nipple 18 and a traditional ring 20 having threads (not shown) form a traditional nipple attachment 22, which is threadable onto the neck of the traditional feeding bottle. Ring 20 typically has a diameter of about 42-44 mm.

The present inventions relates to modifications to a disposable liquid container such as a plastic, water-filled, disposable bottle. In a first embodiment, the modification includes making the necks of conventional disposable bottles wider so that they are the same size as other, internally-threaded attachments such as nipple attachments used on baby feeding bottles. Modifying the neck to make it wider allows for easy addition of a powdered substance such as baby formula to the bottle. This would allow for ease and less spillage of the powder when pouring powdered formula or other powdered mix into the disposable bottle. It would also allow for conventional nipple attachments to be directly attached to disposable water bottles. A parent, therefore, can quickly and easily adapt a standard beverage bottle for use in drinking by an infant or toddler.

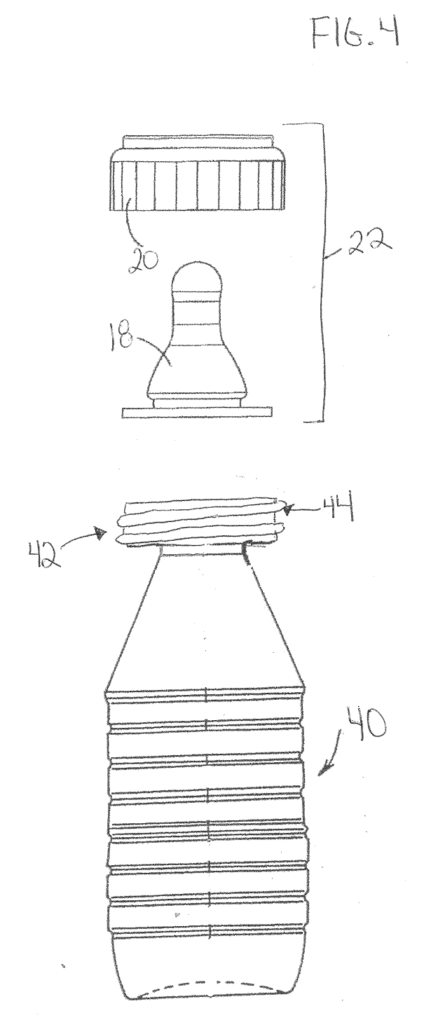

FIG. 3 shows a perspective view one embodiment of the present invention. As can be seen in FIG. 3, a pre-filled, disposable bottle 30 includes an externally-threaded neck 32, modified according to the present invention, and having a diameter of about 42-44 mm. Also seen in FIG. 3 is traditional nipple attachment 22. After removing the screw cap (not shown) from bottle 30, traditional nipple attachment 22 may be directly attached to bottle 30. When traditional nipple attachment 22 is screwed onto bottle 30, a feeding bottle is easily obtained and is quickly ready to be given to an infant or toddler.

In a second embodiment, the external threads of the disposable bottles are made larger such that they can directly accept different, internally-threaded attachments such as conventional nipple attachments. Referring now to FIG. 4, there is shown a perspective view of a second embodiment of the present invention. As seen therein, a pre-filled, disposable bottle 40 includes an externally-threaded neck 42 having threads 44. When compared to threads 6 on neck 4 of bottle 2 in FIG. 3, one can see that threads 44 are larger then threads 6. Also seen in FIG. 4 is traditional nipple attachment 22. After removing the screw cap (not shown) from bottle 40, traditional nipple attachment 22 may be directly attached to bottle 40. When traditional nipple attachment 22 is screwed onto bottle 40, a feeding bottle is easily obtained and is quickly ready to be given to an infant or toddler.

In a third embodiment, the neck of the disposable bottle is elongated. This adds extra space in the pre-filled, disposable bottle not occupied by water or other liquid. The extra space allows for easy addition of a powdered substance because it eliminates overflow of the liquid from the bottle and, thereby, waste of the liquid and/or powdered substance.

The present invention alleviates difficulties often associated with adding a powdered mix such as, for example, powdered baby formula to a conventional disposable water bottle. The present invention eliminates waste of containers, as well as spillage of the liquids and the powdered mixes. The present invention also helps the environment by providing easily-recyclable containers and by requiring less water and detergent for cleaning additional containers. There is no longer a need for a conventional bottle because adding and mixing can all be done in the same container. In addition, the larger neck will have larger covers, which eliminates a choking hazard for infants and young children.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A disposable container pre-filled with a liquid, wherein the container includes a neck having a diameter, wherein the diameter has been modified to allow a nipple attachment to be directly attached to the neck.

2. The disposable container of claim 1, wherein the container comprises a bottle.

3. The disposable container of claim 2, wherein the liquid is water.

4. The container of claim 1, wherein the diameter of the neck is about 42-44 mm.

5. The container of claim 1, wherein the neck comprises one or more threads that have been modified by enlarging the threads.
